(19) United States
(12) Patent Application Publication
(10) Pub. No.: US 2024/0336101 A1
(43) Pub. Date: Oct. 10, 2024

(54) METHOD FOR CONTROLLING VEHICLE DAMPER TO REDUCE CONTACT SHOCK AND SYSTEM THEREOF

(71) Applicant: HL MANDO CORPORATION, Pyeongtaek (KR)

(72) Inventor: Jaegon LEE, Seongnam (KR)

(21) Appl. No.: 18/489,865

(22) Filed: Oct. 19, 2023

(30) Foreign Application Priority Data
Apr. 7, 2023 (KR) 10-2023-0046054

(51) Int. Cl. B60G 17/016

(52) U.S. Cl. CPC B60G 17/0164; B60G 2400/104; B60G 2400/20; B60G 2500/10; B60G 2600/1874; B60G 2600/1877

(57) ABSTRACT

A vehicle damper control method to reduce a contact shock includes: S10) estimating a future displacement of a damper of a vehicle; and S20) controlling a damping force of the damper based on the estimated future displacement of the damper.

### CROSS-REFERENCE TO RELATED APPLICATION

This application claims priority under 35 U.S.C. § 119 to Korean Patent Application No. 10-2023-0046054, filed on Apr. 7, 2023, in the Korean Intellectual Property Office (KIPO), the disclosure of which is incorporated by reference herein in its entirety.

### 1. TECHNICAL FIELD

The present disclosure relates to a vehicle damper control method and a vehicle damper control system, and more particularly, to a vehicle damper control method capable of reducing a contact shock that may be generated in a vehicle damper.

### 2. DISCUSSION OF RELATED ART

In general, a suspension is installed between wheels and a body of a vehicle to improve riding comfort. Such a suspension may include a spring capable of absorbing vibration or impact of a road surface, and a damper capable of damping free vibration of the spring to control riding comfort.

Such a damper serves to relieve the spring movement in the process of repeating contraction and relaxation of the spring in the suspension. The rebound of the spring may cause shaking of the vehicle body, and the damper serves to suppress this shaking, and a damping force of the damper may result in riding comfort.

When a stroke of such a damper reaches a minimum (min)/full (e.g., maximum) (max) position, a large shock may occur because components of a suspension bush are in a full compression condition.

Moreover, recent vehicles tend to increase in terms of the weight of the body and the weight of the wheels. The increase in the weight of the body may lead to an increase in the frequency of floor shock, and the increase in the weight of the wheel may lead to an increase in the frequency of rebound shock.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Embodiments of the present disclosure may be directed to a vehicle damper control method and control system capable of reducing contact shock in a vehicle damper.

According to an embodiment, a vehicle damper control method to reduce a contact shock includes: S10) estimating a future displacement of a damper of a vehicle; and S20) controlling a damping force of the damper based on the estimated future displacement of the damper.

In some embodiments, S10) the estimating the future displacement of the damper includes: S11) calculating a velocity and an acceleration of the damper; S12) assuming a range of variation in the calculated velocity and acceleration of the damper; and S13) estimating the future displacement of the damper based on the assumed velocity and acceleration assumed in S12).

In some embodiments, the method may further include: multiplying the velocity and acceleration of the damper with the assumed range of variation assumed in S12) by a gain value according to a frequency.

In some embodiments, the gain value according to the frequency may decrease as the frequency increases.

In some embodiments, the gain value according to the frequency may have a value of 1 when the frequency is 0.

In some embodiments, the gain value according to the frequency may decrease linearly as the frequency increases.

In some embodiments, the gain value according to the frequency may be determined by the following equation:

Gain according to frequency=1−0.02f, where f=damper frequency.

In some embodiments, S20) may include: S21) determining a damping force offset value based on the estimated future displacement of the damper.

In some embodiments, the damping force offset may be a valve input current offset of the damper.

In some embodiments, the input current offset may be 0 when −X<damper stroke<X (where X is a preset value), and the input current offset may increase as an X value increases when damper stroke<−X or damper stroke>X.

In some embodiments, the damper may be a semi-active damper.

In some embodiments, S10) the estimating the future displacement of the damper may include: S11) obtaining a velocity and an acceleration of the damper from a velocity sensor or an acceleration sensor of the damper; S12) assuming a range of variation in the velocity and the acceleration of the damper; and S13) estimating the future displacement of the damper based on the assumed velocity and acceleration assumed in step S12).

According to an embodiment, a vehicle damper control method to reduce a contact shock includes: S10) calculating a velocity and an acceleration of a damper of a vehicle and estimating a future displacement of the damper based on the calculated velocity and acceleration of the damper; and S20) controlling a damping force of the damper based on the estimated future displacement of the damper.

In some embodiments, in S10), the future displacement of the damper may be estimated based on the velocity and the acceleration of the damper calculated by multiplying the calculated velocity and acceleration of the damper by a gain value according to a frequency.

In some embodiments, the gain value according to the frequency may decrease as the frequency increases.

According to an embodiment, a vehicle damper control system to reduce a contact shock includes: a damper displacement estimater configured to estimate a future displacement of a damper of a vehicle; and a damping force offset determiner configured to determine a damping force offset to control a damping force of the damper based on the estimated future displacement of the damper.

In some embodiments, the damper displacement estimater may calculate a velocity and an acceleration of the damper, assume a range of variation in the calculated velocity and acceleration of the damper, and then estimate the future displacement of the damper based on the assumed velocity and acceleration of the damper.

In some embodiments, the assumed velocity and acceleration of the damper may be derived by multiplying the velocity and acceleration of the damper with the assumed range of variation by a gain value according to a frequency.

In some embodiments, in the damping force offset determiner, the damping force offset may be a valve input current offset of the damper.

The vehicle damper control method and control system according to the present disclosure may estimate the future displacement of the damper and adjust the damping force of the damper based on the estimated future displacement, thereby reducing contact shock.

Moreover, the vehicle damper control method and control system according to the present disclosure may reduce contact shock, thereby improving durability (e.g., endurance) of the vehicle body and its components.

The effects of the present disclosure are not limited to the effects described above, and other effects not mentioned are clear to a person having ordinary skill in the art (PHOSITA) based on the description of the claims.

### BRIEF DESCRIPTION OF THE DRAWINGS

A more complete appreciation of the present disclosure will become more apparent by describing in detail exemplary embodiments thereof with reference to the accompanying drawings, wherein:

FIG. 1 is a graph illustrating an actual damper stroke and a damper displacement estimated according to the present disclosure;

FIG. 2 is a graph illustrating a gain according to a frequency according to the present disclosure;

FIG. 3 is a graph before gain compensation according to a frequency on a high-frequency road surface;

FIG. 4 is a graph after gain compensation according to a frequency on a high-frequency road surface;

FIG. 5 is a graph illustrating another example of a gain according to a frequency according to the present disclosure;

FIG. 6 is a block diagram illustrating a damper control method according to the present disclosure;

FIG. 7 is a graph illustrating a current offset according to a damper stroke according to the present disclosure;

FIG. 8 is a view illustrating a semi-active damper;

FIG. 9 is a cross-sectional view illustrating a damping force variable valve in FIG. 8; and

FIGS. 10 to 12 are graphs illustrating test results of vehicle damper control according to the present disclosure.

### DETAILED DESCRIPTION

Advantages and features of the present disclosure, and methods of achieving them, will become clear with reference to the detailed description of the following embodiments described in conjunction with the accompanying drawings. However, the present disclosure is not limited to the embodiments disclosed below, but will be implemented in various different forms, these embodiments merely make the disclosure of the present disclosure complete, and are provided to fully inform those of ordinary skill in the art to which the present disclosure belongs. The present disclosure is only defined by the scope of the claims. Thus, in some embodiments, well-known process steps, well-known device structures, and well-known techniques have not been described in detail in order to avoid obscuring the interpretation of the present disclosure. Like reference numbers designate like elements throughout the specification.

In the drawings, the thickness is enlarged to clearly express the various layers and regions. Like reference numerals have been assigned to like parts throughout the specification. When a part such as a layer, film, region, plate, etc. is said to be “on” another part, this includes not only the case where it is “directly on” another part, but also the case where there is another part in between. Conversely, when a part is said to be “directly on” another part, it means that there is no other part in between. In addition, when a part such as a layer, film, region, plate, etc. is said to be “below” another part, this includes not only the case where it is “directly below” the other part, but also the case where another part is present in the middle. Conversely, when a part is said to be “directly below” another part, it means that there is no other part in between.

The spatially relative terms “below”, “beneath”, “lower”, “above”, “upper”, and the like may be used to easily describe the correlation between elements or components and other elements or components. Spatially relative terms should be understood as encompassing different orientations of elements in use or operation in addition to the orientations illustrated in the drawings. For example, when flipping elements illustrated in the drawings, elements described as “below” or “beneath” other elements may be disposed “above” the other elements. Thus, the exemplary term “below” may include directions of both below and above. Elements may also be oriented in other orientations, and thus spatially relative terms may be interpreted according to orientation.

As used herein, when a part is said to be connected to another part, this includes not only the case where it is directly connected, but also the case where it is connected with another element interposed therebetween. In addition, when a part includes a certain component, it means that it may further include other components without excluding other components unless otherwise specified.

As used herein, terms such as first, second, and third may be used to describe various components, but these components are not limited by the terms. The terms are used for the purpose of distinguishing one component from other components. For example, a first component could be termed a second or third component, and the like, and similarly, a second or third component could also be termed interchangeably, without departing from the scope of the present disclosure.

Unless otherwise defined, all terms (including technical and scientific terms) as used herein may be used in a meaning commonly understood by those of ordinary skill in the art to which the present disclosure belongs. In addition, terms defined in commonly used dictionaries are not interpreted ideally or excessively unless explicitly specifically defined.

Hereinafter, a vehicle damper control method capable of reducing contact shock according to an embodiment of the present disclosure will be described in detail with reference to the drawings.

A vehicle damper control method according to the present disclosure may reduce contact shock by estimating (e.g., predicting) reaching of a damper at its full (e.g., maximum) compression/tension position.

A vehicle damper control method capable of reducing a contact shock according to a first embodiment of the present disclosure may include S10) estimating a future displacement (e.g., a future stroke) of a damper of a vehicle; and S20) controlling a damping force of the damper based on the estimated future displacement of the damper, where S10) the estimating the future displacement of the damper may include: S11) estimating (e.g., calculating) a velocity and an acceleration of the damper; S12) assuming a range of variation in the estimated velocity and acceleration of the damper; and S13) estimating the future displacement of the damper based on the assumed velocity and acceleration assumed in S12).

In the present disclosure, the contact shock may be reduced based on the estimation of the future displacement of the damper, and the process of estimating the reaching of the damper at the full tensile/compression position will be described below.

First, 1) an acceleration and a velocity of a damper are estimated at a current time. The velocity and the acceleration of the damper may be calculated based on a position (e.g., a stroke) of the damper as follows, and the position of the damper (dstroke) may be detected by a position sensor.

dstroke/dt=Velocity, dVelocity/dt=Acceleration

2) Next, a range of variation (e.g., a change width) (±VelVariation) of the velocity of the damper and a range of variation (±AccVariation) of the acceleration of the damper are assumed.

VelTemp=Velocity±VelVariation,

AccTemp=Acceleration±AccVariation

In an example, the range of variation of the velocity and acceleration of the damper and a future time may be assumed as follows according to the present disclosure.

| | Acceleration | | |
|---|---|---|---|
| | variation | Velocity variation | |
| | (AccVariation) | (VelVariation) | Future time |
| Value | ±1 m/s² | ±0.03 m/s | 50 ms |

3) Based on the assumed velocity (VelTemp) and acceleration (AccTemp) of the damper, a damper displacement (StrokeTemp) at a future time may be estimated as follows.

ΔVelTemp=AccTemp*ΔT,

$$ΔStroke Temp = Vel Temp * Δ T + 1 / 2 * AccTemp * Δ {T}^{2}$$

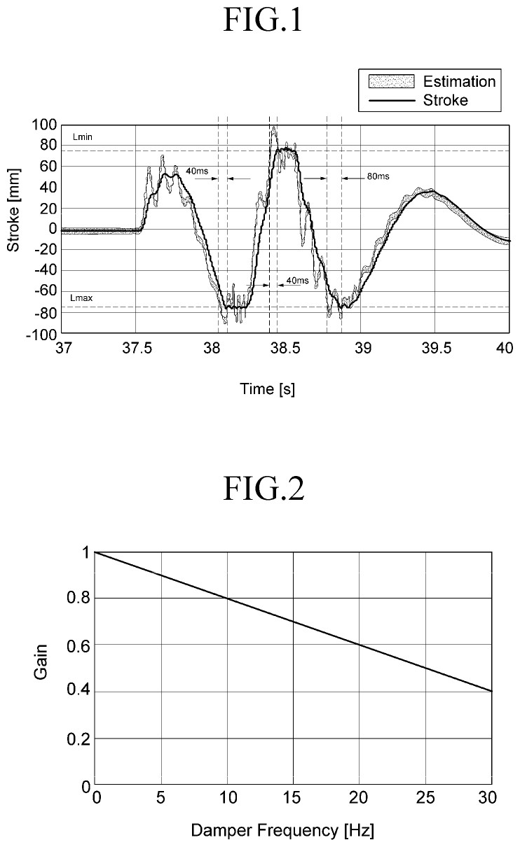

FIG. 1 is a graph illustrating an actual damper stroke and a damper displacement estimated according to the present disclosure, where a solid line represents the actual damper stroke. In FIG. 1, Lmin represents a full (e.g., maximum) compression of the damper, and Lmax represents a full rebound. As illustrated, it may be appreciated that it is predictable at least 40 ms before contact with maximum tension/compression.

Meanwhile, on a high-frequency road surface, the damper acceleration may increase, and accordingly, an estimation value may become sensitive, and estimation performance may deteriorate. Accordingly, as another embodiment of the present disclosure, the estimated displacement may be compensated as follows.

Here, for compensation, the velocity and the acceleration of the damper derived as described above are multiplied by a gain value according to a frequency.

VelTemp=(Velocity±VelVariation)*FreqGain,

AccTemp=(Acceleration±AccVariation)*FreqGain

FIG. 2 is a graph illustrating an example of a gain (FreqGain) according to a frequency. In FIG. 2, the frequency-dependent gain (FreqGain) decreases linearly as the frequency increases and may be expressed as follows.

$$Freq Gain = 1 - 0.02 f ( f = damper frequency )$$

In FIG. 2, a slope may be set differently.

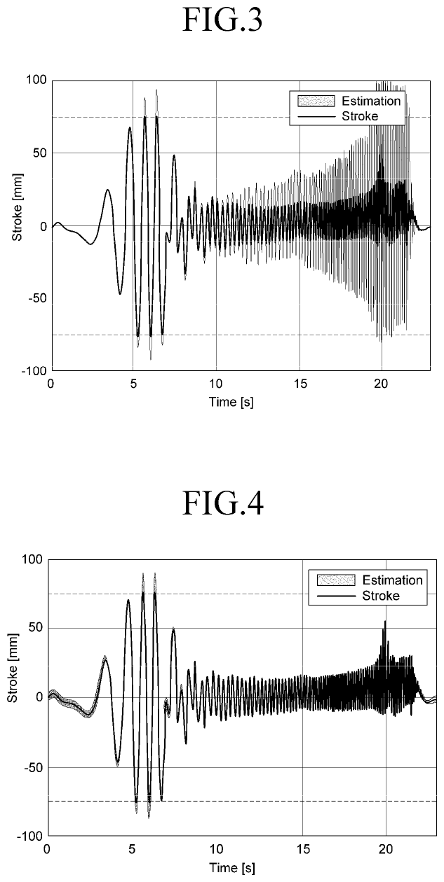

FIG. 3 is a graph before gain compensation according to a frequency on a high-frequency road surface, and FIG. 4 is a graph after gain compensation according to a frequency on a high-frequency road surface.

Although there was a difference between the actual stroke and the estimated value on the high-frequency road surface, it was appreciated that the difference with respect to the actual stroke was greatly reduced after compensating for the gain according to the frequency.

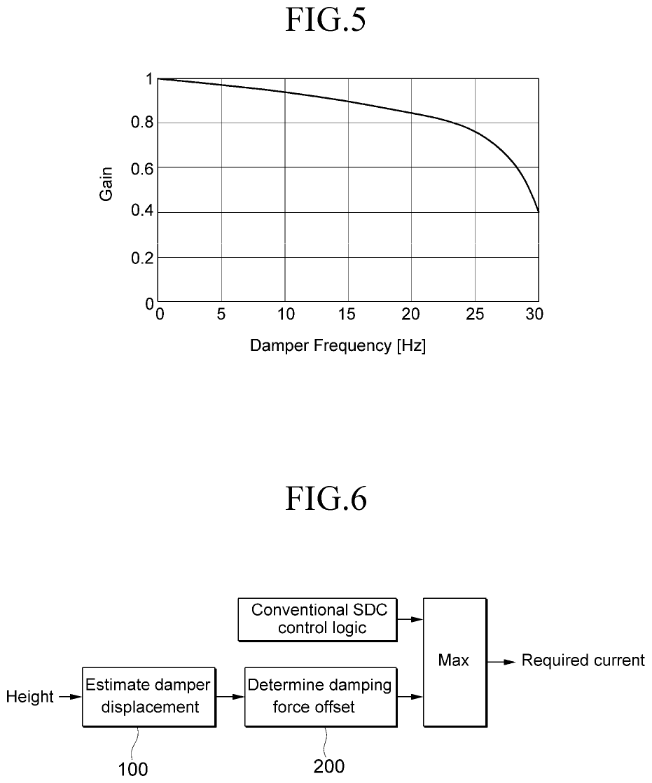

FIG. 5 illustrates a gain (FreqGain) according to a frequency according to another embodiment.

As illustrated in FIG. 5, the frequency-dependent gain (FreqGain) may decrease exponentially as the frequency increases and may be expressed as follows.

$$Freq Gain = 2 - {a}^{f} ( a > 1 , f = damper frequency )$$

Here, a value “a” may be set differently according to the vehicle, and as illustrated in FIG. 5, for example, the value “a” may have a value satisfying FreqGain=0.4 when f=30.

Next, a damper control method to reduce contact shock based on the estimated displacement of the damper which is estimated as described above will be described.

FIG. 6 is a block diagram illustrating a damper control method according to the present disclosure, wherein a damping force of the damper is determined based on the aforementioned damper displacement estimation.

Specifically, a damping force offset value is determined based on the damper displacement estimation.

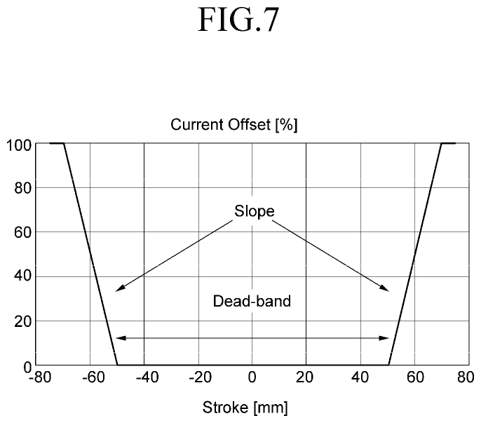

FIG. 7 illustrates a current offset according to a damper stroke, where the offset value is 0 when the stroke satisfies −X<dstroke<X, and the offset value linearly increases as the X value increases when dstroke<−X or dstroke>X. Here, X may be in a range from 40 to 60 mm, and FIG. 7 shows a case where X is 50.

Referring to FIG. 7, for example, the current offset value is 0 when the damper stroke is within a range of about +50. In addition, the current offset value increases in a negative direction at a damper stroke<−50 or increases in a positive direction at a damper stroke>50, where the current offset value increases as the X value increases and becomes 100% at around ±70. The X value and an offset increase slope may be appropriately adjusted according to the vehicle.

For the damping force of the damper, the damping force offset value determined as described above may be reflected to the conventional semi-active damper control (SDC) logic to calculate an input current of a variable valve of the damper. Then, control is made by using a maximum value as a required current, as compared with a current which is calculated in other required controls in the vehicle, for example, load control, handling control, motion control, and the like.

In the present disclosure, the sense of heterogeneity of control may be minimized by applying the current offset characteristic according to the estimated damper stroke and by using proportional control.

Regarding the semi-active damper, there is a semi-active damper that changes the damping force by using a variable valve, and there is a case where a solenoid valve is used as a variable valve. In such a case, as an input current value is changed during compression or tension of a damper cylinder by a piston, a spool rod of the solenoid valve operates with a different operating force, so a direction of a passage or a degree of valve opening and closing changes and a damping force is generated in response to the change. That is, the semi-active damper is installed with a damping force variable valve in a common piston-cylinder damper and adjusts the damping force by changing the degree of opening and closing of the valve according to the input current value of the solenoid valve during a compression or tension stroke.

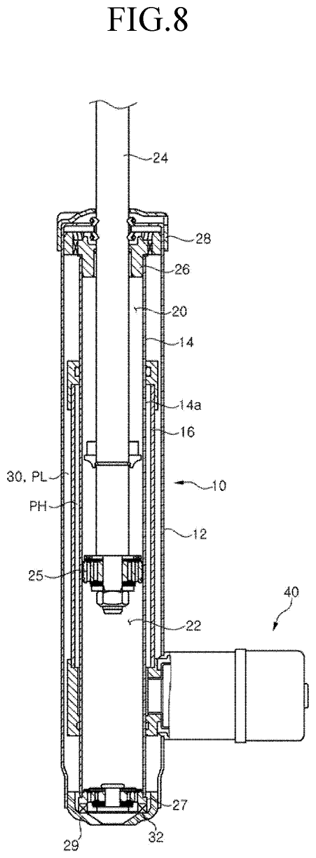

FIG. 8 illustrates an example of a semi-active damper. A semi-active damper 10 illustrates in FIG. 8 includes a base shell 12 and an inner tube 14 installed in the base shell 12 and including a piston rod 24 installed therein to be movable in a longitudinal direction. A rod guide 26 and a body valve 27 are installed respectively at the top and bottom of the inner tube 14 and the base shell 12. In addition, a piston valve 25 is coupled to one end of the piston rod 24 in the inner tube 14, and the piston valve 25 partitions an inner space of the inner tube 14 into a rebound chamber 20 and a compression chamber 22. An upper cap 28 and a base cap 29 are installed respectively on upper and lower portions of the base shell 12.

A reservoir chamber 30 is formed between the inner tube 14 and the base shell 12 to compensate for a volume change in the inner tube 14 according to a reciprocating motion of the piston rod 24. A flow of a working fluid between the reservoir chamber 30 and the compression chamber 22 is controlled by the body valve 27.

A separator tube 16 is installed in the base shell 12. By this separator tube 16, the inside of the base shell 12 is partitioned into a high pressure chamber PH connected to the rebound chamber 20 and a low pressure chamber PL serving as the reservoir chamber 30.

The high pressure chamber PH is connected to the rebound chamber 20 through a hole 14a formed in the inner tube 14. Meanwhile, the low pressure chamber PL is connected to the compression chamber 22 through a lower passage 32 formed between a body of the body valve 27 and the base shell 12.

A damping force variable valve 40 is mounted on one side of the base shell 12 to appropriately adjust the damping force characteristics according to the road surface and driving conditions.

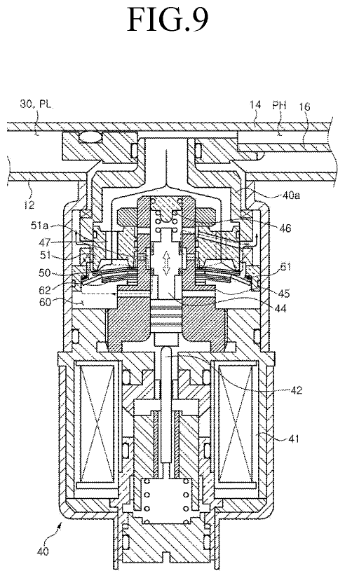

FIG. 9 is a cross-sectional view illustrating a damping force variable valve used in a semi-active damper.

In the damping force variable valve 40, an oil passage connected to each of the base shell 12 and the separator tube 16 and communicating with each of the high pressure chamber PH and the low pressure chamber PL is formed. In addition, a spool 44 which moves by driving of an actuator 42 is installed in the damping force variable valve 40, and according to the movement of the spool 44, an internal passage communicating with the high pressure chamber PH and the low pressure chamber PL varies to vary the damping force of the damper 10.

The damping force variable valve 40 includes therein a disk valve 50 and a back pressure chamber 60 used to vary the damping force of the shock absorber. The back pressure chamber 60 is provided behind the disk valve 50 to have back pressure to press the disk valve 50.

The disk valve 50 is installed behind a retainer 51 to cover a passage 51a formed perpendicular to the retainer 51. The retainer 51 is connected to the above-described high pressure chamber PH of the shock absorber through a connector 40a. Accordingly, a high pressure working fluid introduced from the high pressure chamber PH through the connector 40a passes through the passage 51a and flows toward the disk valve 50.

The damping force variable valve 40 includes the actuator 42 whose moving distance varies according to a current value applied to the solenoid 41. In addition, the damping force variable valve 40 includes the spool 44 disposed on the same axis as the actuator 42 and linearly moving in conjunction with the actuator 42. The spool 44 moves along a spool guide 45, one end of the spool 44 may contact the actuator 42 and another end of the spool 44 may be elastically supported by a compression spring 46. The spool 44 moves forward by compression of the actuator 42 and retracts by a restoring force of the compression spring 46.

As the spool 44 moves according to the driving of the solenoid, the interaction between the spool 44 and the spool guide 45 allows control of opening and closing and/or the degree of opening and closing of the back pressure control passage 47 from an upstream side of the disk valve 50 toward the back pressure chamber 60.

A ring member 61 at the back pressure chamber 60 restricts flow of the working fluid to the low pressure chamber PL such that a back pressure is formed in the back pressure chamber 60. The ring member 61 is pressed by a pressure disk 62 to restrict flow of the working fluid toward the periphery of the ring member 61. The pressure disk 62 presses the ring member 61 with a considerable pressure such that a back pressure is formed in the back pressure chamber 60.

In the damping force variable valve 40, the disk valve 50 is formed by stacking a plurality of disks to cover the passage 51a formed perpendicular to the retainer 51. In addition, the disc valve 50 is also pressed by the pressure disc 62 located below the disc valve 50. The degree of opening of the disc in the disc valve 50 is controlled by a change in the pressure of the working fluid through the passage 51a and a change in the back pressure to the disc valve 50 in the back pressure chamber 60, and accordingly, the damping force may vary.

As described above, in the semi-active damper 10, the damping force is adjusted by changing the degree of opening and closing of the valve according to the solenoid valve input current value in the damping force variable valve 40 during the compression or tension stroke. In the present disclosure, the current offset (see FIG. 7) characteristics according to the estimated damper stroke are applied, and proportional control is also applied, thereby minimizing control heterogeneity.

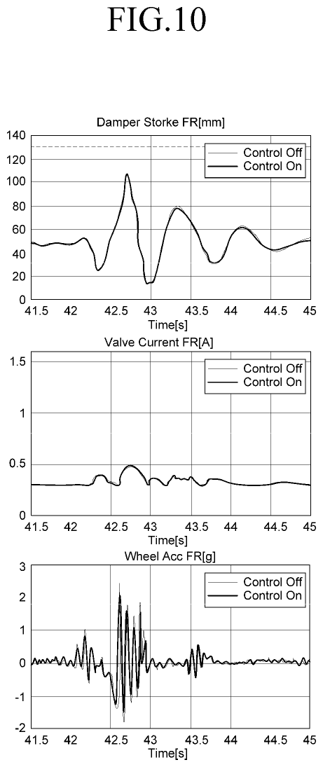

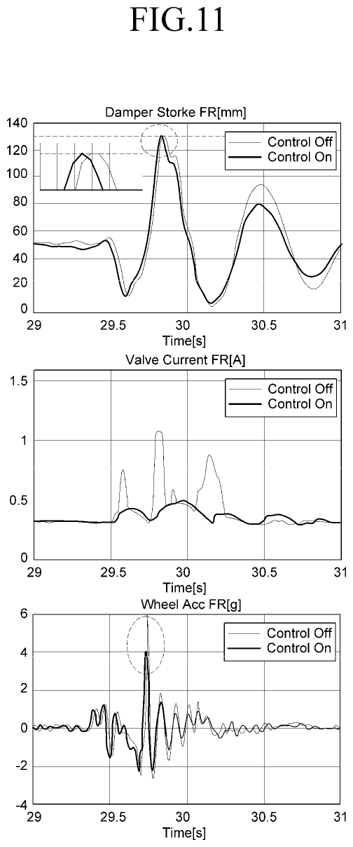

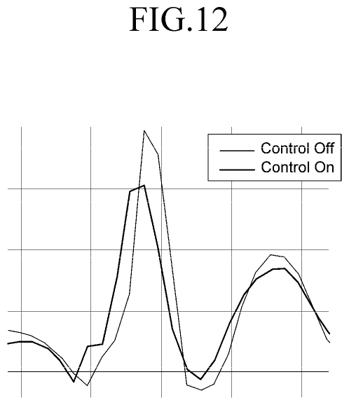

FIGS. 10 to 12 are graphs illustrating test results of damper control according to the present disclosure. FIG. 10 illustrates a damper stroke, a valve current, and a wheel acceleration in a full rebound shock non-occurrence condition (field, 20 kph@Bump), FIG. 11 illustrates a damper stroke, a valve current, and a wheel acceleration in a full rebound shock occurrence condition (field, 30 kph@Bump), and FIG. 12 is a detailed view illustrating a part indicated by a dotted line in the wheel acceleration in FIG. 11.

In the full rebound shock non-occurrence condition (field, 20 kph@Bump) in FIG. 10, it was appreciated that there was no control intervention when the damper stroke occurs near a neutral position.

On the other hand, in the full rebound shock occurrence condition (field, 30 kph@Bump) in FIG. 11, when the damper control according to the present disclosure is not operated (off), it was appreciated that there was a maintain section in the damper stroke Lmax (130 mm) due to a rebound stopper collision, and accordingly, a wheel G value increased significantly (5.96 g).

In contrast, when the damper control according to the present disclosure is activated (on), it was appreciated that the shock was reduced due to an increase in tensile damping force (1.1 A) before the rebound stopper collision, and the low wheel G level (4.12 g) was maintained.

In addition, the wheel acceleration was decreased by 30% in terms of a peak-to-peak and decreased by 20% in terms of a root mean square (RMS), as illustrated in FIG. 12.

As described above, in the vehicle damper control according to the present disclosure, contact shock may be reduced by controlling a damping force of the damper based on estimation of the future displacement of the damper and estimation of the reaching of the maximum tension/compression position of the damper.

When a contact shock occurs according to the maximum tension/compression of the damper, a high energy is generated, resulting in misalignment between parts and deterioration in durability of the vehicle body and its components. However, in the present invention, as described above, the durability of the vehicle body and its components is improved by reducing the contact shock.

Hereinafter, a vehicle damper control system to reduce contact shock according to an embodiment of the present disclosure will be described with reference to the damper control method described above.

A vehicle damper control system to reduce contact shock according to the present disclosure includes a damper displacement estimater 100 and a damping force offset determiner 200.

The damper displacement estimater 100 which estimates a future displacement of the damper estimates an acceleration and a velocity of the damper at the current time as described in the aforementioned damper control method, then assumes a range of variation in the velocity and acceleration of the damper, and then, estimates the future displacement of the damper based on the assumed velocity and acceleration of the damper.

In addition, the velocity and acceleration of the damper with the assumed certain range of variation are multiplied by a gain value according to a frequency, and accordingly, the future displacement of the damper may be estimated based on the assumed velocity and acceleration of the damper.

A specific process of estimating the future displacement of the damper is the same as in the damper control method.

The damping force offset determiner 200 determines a damping force offset of the damper based on the future displacement of the damper estimated by the damper displacement estimater 100.

As described in the aforementioned damper control method, the damping force offset determination may determine a current offset according to the damper stroke as illustrated in FIG. 6.

As illustrated in FIG. 7, the input current offset may be 0 when −X<damper stroke<X (where X is a preset value), and the input current offset may increase as an X value increases when damper stroke<−X or damper stroke>X.

As such, for the damping force of the damper, the damping force offset value determined as described above may be reflected to the conventional semi-active damper control (SDC) logic to calculate an input current of a variable valve of the damper, and control is made by using a maximum value as a required current, as compared with a current which is calculated in other required controls in the vehicle, for example, load control, handling control, motion control, and the like.

A specific process for determining the damping force offset of the damper is the same as in the damper control method.

Hereinafter, a vehicle damper control method capable of reducing a contact shock according to a second embodiment of the present disclosure will be described.

A vehicle damper control method to reduce a contact shock according to a second embodiment of the present disclosure includes: S10) estimating a future displacement of a damper of a vehicle; and S20) controlling a damping force of the damper based on the estimated future displacement of the damper, where S10) the estimating the future displacement of the damper includes S11) obtaining a velocity and an acceleration of the damper from a velocity sensor or an acceleration sensor of the damper; S12) assuming a range of variation in the velocity and the acceleration of the damper; and S13) estimating the future displacement of the damper based on the assumed velocity and acceleration assumed in step S12).

That is, the difference between the present embodiment and the previous embodiment is that the damper velocity and acceleration were estimated based on the damper position (e.g., stroke) in the previous embodiment, but in the present embodiment, the damper velocity and acceleration were estimated using an acceleration sensor for detecting an acceleration of the damper or a velocity sensor for detecting a velocity of the damper. Specifically, the acceleration may be calculated by differentiating the velocity detected by the velocity sensor of the damper with respect to time, and the velocity may be calculated by integrating the acceleration detected by the acceleration sensor of the damper with respect to time.

Based on the velocity and acceleration of the damper thus obtained, the future displacement of the damper may be estimated. Estimating the future displacement of the damper may be conducted similarly to the first embodiment. The range of variation is assumed in the detected velocity and acceleration of the damper, and the future displacement of the damper may be estimated based on the assumed velocity and acceleration.

Other configurations and effects are the same as those of the previous embodiment, so detailed descriptions thereof will be omitted here.

Hereinafter, a vehicle damper control method capable of reducing a contact shock according to a third embodiment will be described.

A vehicle damper control method capable of reducing a contact shock according to a third embodiment of the present disclosure includes: S10) estimating (e.g., calculating) a velocity and an acceleration of a damper of a vehicle and estimating a future displacement of the damper based on the estimated velocity and acceleration of the damper; and S20) controlling a damping force of the damper based on the estimated future displacement of the damper, where in S10), the future displacement of the damper may be estimated based on the velocity and the acceleration of the damper calculated by multiplying the estimated velocity and acceleration of the damper by a gain value according to a frequency.

That is, the difference between the present embodiment and the previous embodiment is that in the present embodiment, the future displacement of the damper is estimated based on the velocity and acceleration of the damper calculated by multiplying the gain value according to the frequency, without assuming the range of variation for the estimated velocity and acceleration of the damper estimated in S10).

Other configurations and effects may be the same as those of the previous embodiment.

Hereinabove, the present disclosure has been described with reference to preferred embodiments, but the present disclosure is not limited thereto, and various modifications may be made by those skilled in the art within the scope without departing from the gist of the present disclosure described in the claims below.

What is claimed is:

1. A vehicle damper control method to reduce a contact shock, the method comprising:
S10) estimating a future displacement of a damper of a vehicle; and
S20) controlling a damping force of the damper based on the estimated future displacement of the damper.

2. The method of claim 1, wherein S10) the estimating the future displacement of the damper comprises:
S11) calculating a velocity and an acceleration of the damper;
S12) assuming a range of variation in the calculated velocity and acceleration of the damper; and
S13) estimating the future displacement of the damper based on the assumed velocity and acceleration assumed in S12).

3. The method of claim 2, further comprising:
multiplying the velocity and acceleration of the damper with the assumed range of variation assumed in S12) by a gain value according to a frequency.

4. The method of claim 3, wherein the gain value according to the frequency decreases as the frequency increases.

5. The method of claim 4, wherein the gain value according to the frequency has a value of 1 when the frequency is 0.

6. The method of claim 4, wherein the gain value according to the frequency decreases linearly as the frequency increases.

7. The method of claim 6, wherein the gain value according to the frequency is determined by the following equation:
$$Gain according to frequency = 1 - 0.02 f , where f = damper frequency .$$

8. The method of claim 1, wherein S20) comprises:
S21) determining a damping force offset value based on the estimated future displacement of the damper.

9. The method of claim 8, wherein the damping force offset is a valve input current offset of the damper.

10. The method of claim 9, wherein the input current offset is 0 when −X<damper stroke<X (where X is a preset value), and the input current offset increases as an X value increases when damper stroke<−X or damper stroke>X.

11. The method of claim 1, wherein the damper is a semi-active damper.

12. The method of claim 1, wherein S10) the estimating the future displacement of the damper comprises:
S11) obtaining a velocity and an acceleration of the damper from a velocity sensor or an acceleration sensor of the damper;
S12) assuming a range of variation in the velocity and the acceleration of the damper; and
S13) estimating the future displacement of the damper based on the assumed velocity and acceleration assumed in step S12).

13. A vehicle damper control method to reduce a contact shock, the method comprising:
S10) calculating a velocity and an acceleration of a damper of a vehicle and estimating a future displacement of the damper based on the calculated velocity and acceleration of the damper; and
S20) controlling a damping force of the damper based on the estimated future displacement of the damper.

14. The method of claim 13, wherein in S10), the future displacement of the damper is estimated based on the velocity and the acceleration of the damper calculated by multiplying the calculated velocity and acceleration of the damper by a gain value according to a frequency

15. The method of claim 14, wherein the gain value according to the frequency decreases as the frequency increases.

16. A vehicle damper control system to reduce a contact shock, comprising:
a damper displacement estimater configured to estimate a future displacement of a damper of a vehicle; and
a damping force offset determiner configured to determine a damping force offset to control a damping force of the damper based on the estimated future displacement of the damper.

17. The vehicle damper control system of claim 16, wherein the damper displacement estimater calculates a velocity and an acceleration of the damper, assumes a range of variation in the calculated velocity and acceleration of the damper, and then estimates the future displacement of the damper based on the assumed velocity and acceleration of the damper.

18. The vehicle damper control system of claim 17, wherein the assumed velocity and acceleration of the damper are derived by multiplying the velocity and acceleration of the damper with the assumed range of variation by a gain value according to a frequency.

19. The vehicle damper control system of claim 16, wherein in the damping force offset determiner, the damping force offset is a valve input current offset of the damper.

20. The vehicle damper control system of claim 19, wherein the input current offset is 0 when −X<damper stroke<X (where X is a preset value), and the input current offset increases as an X value increases when damper stroke<−X or damper stroke>X.
